(19) United States
(12) Patent Application Publication
(10) Pub. No.: US 2018/0165494 A1
(43) Pub. Date: Jun. 14, 2018

(54) TOUCH SENSOR CAPABLE OF RECOGNIZING FINGERPRINTS, DISPLAY DEVICE ADOPTING THE TOUCH SENSOR, AND ELECTRONIC DEVICE ADOPTING THE TOUCH SENSOR

(71) Applicant: SAMSUNG ELECTRONICS CO., LTD., Suwon-si (KR)

(72) Inventor: Hyunjoon KIM, Seoul (KR)

(73) Assignee: SAMSUNG ELECTRONICS CO., LTD., Suwon-si (KR)

(21) Appl. No.: 15/597,299

(22) Filed: May 17, 2017

(30) Foreign Application Priority Data
Dec. 12, 2016 (KR) 10-2016-0168717

(51) Int. Cl. G06K 9/00; G06F 3/044; G02B 27/28

(52) U.S. Cl. CPC G06K 9/0002; G02B 27/286; G06F 3/044

(57) ABSTRACT

Provided is a touch sensor including a substrate; an electrode layer disposed on a top surface of the substrate, the electrode layer including a first electrode layer and a second layer that intersect each other, and a dielectric layer disposed between the first electrode layer and the second electrode layer; a transparent cover disposed on the electrode layer; and a random pattern layer including an aperiodic pattern. The random pattern layer reduces a Moire phenomenon that may occur when periodic pattern layers overlap.

### CROSS-REFERENCE TO RELATED APPLICATION

This application claims priority from Korean Patent Application No. 10-2016-0168717, filed on Dec. 12, 2016, in the Korean Intellectual Property Office, the disclosure of which is incorporated herein in its entirety by reference.

### BACKGROUND

### 1. Field

The present disclosure relates to a touch sensor capable of recognizing a fingerprint pattern, a display device adopting the touch sensor, and an electronic device adopting the touch sensor.

### 2. Description of the Related Art

The demand for personal authentication using unique personal characteristics such as fingerprints, voice, face, hands, irises, or the like has been gradually increasing. Personal authentication is usually implemented in banking devices, access control systems, mobile devices, notebook computers, etc., and recently, with the wide spread of mobile devices such as smartphones, fingerprint recognition devices for personal authentication have been adopted to protect the high quantity of security information stored in smartphones.

Recently, as technologies related to smartphones and wearable devices have matured, techniques for directly performing fingerprint recognition on a display screen have been developed for both design purposes and user convenience. One of those techniques involves using a structure in which a transparent touch sensor using a capacitive scheme is disposed on a display. In this structure, an electrode structure of a touch sensor, an electrode structure for touch driving, a pixel structure of a display panel, and so forth are disposed in a stacked manner. A pixel pattern of the display panel and an electrode pattern of the touch sensor are periodically repeated. When periodic patterns overlap, an interference pattern may appear, which is referred to as a Moire pattern. The Moire pattern may distort an image or induce a dizzying sensation in a user, thus degrading display quality.

### SUMMARY

The present disclosure provides a touch sensor which may recognize a fingerprint and reduce a Moire phenomenon.

The present disclosure also provides a display device including the touch sensor and an electronic device including the touch sensor.

Additional aspects will be set forth in part in the description which follows and, in part, will be apparent from the description, or may be learned by practice of the presented exemplary embodiments.

According to an aspect of an exemplary embodiment, a touch sensor capable of recognizing a finger includes a substrate; an electrode layer disposed on a top surface of the substrate and including a first electrode layer and a second electrode layer that intersect each other, and a dielectric layer between the first electrode layer and the second electrode layer; a transparent cover disposed on the electrode layer; and a random pattern layer including an aperiodic pattern.

The random pattern layer may be disposed on a bottom surface of the transparent cover.

The random pattern layer may be disposed on a bottom surface of the substrate.

The touch sensor may further include a support plate including the random pattern layer.

The touch sensor may further include a polarization panel which reduces reflected light of external light, and the random pattern layer may be disposed on the polarization panel.

According to an aspect of another exemplary embodiment, a display device includes a display panel configured to display an image; a protection panel disposed outside the display panel; a touch sensor disposed outside the protection panel and including a substrate, an electrode layer disposed on a top surface of the substrate, and a transparent cover disposed on the electrode layer. The electrode layer includes a first electrode layer and a second electrode layer that intersect each other, and a dielectric layer disposed between the first electrode layer and the second electrode layer; and a random pattern layer including an aperiodic pattern.

The random pattern layer may be disposed on a bottom surface of the transparent cover.

The random pattern layer may be disposed on a bottom surface of the substrate.

The touch sensor may further include a support plate, and the random pattern layer may be disposed on the support plate.

The touch sensor may further include a polarization panel which reduces reflected light of external light, and the random pattern layer may be disposed on the polarization panel.

The random pattern layer may be disposed on one of a top surface and a bottom surface of the protection panel.

The random pattern layer may be disposed on a bottom surface of the display panel.

The display device may further include a polarization panel which reduces reflected light of external light, and the random pattern layer may be disposed on the polarization panel.

The display device may further include a touch panel for receiving a user input, the touch panel disposed between the protection panel and the display panel.

The touch sensor may function as a touch panel for receiving a user input.

According to an aspect of another exemplary embodiment, an electronic device may include a body and the display device described above supported in the body.

### BRIEF DESCRIPTION OF THE DRAWINGS

The above and/or other aspects will become apparent and more readily appreciated from the following description of various exemplary embodiments, taken in conjunction with the accompanying drawings in which:

FIG. 1A is a perspective view of an electronic device according to an exemplary embodiment;

FIG. 1B is a perspective view of an electronic device according to an exemplary embodiment;

FIG. 2 is a schematic cross-sectional view of a display device according to an exemplary embodiment;

FIG. 3 is a schematic cross-sectional view of an active matrix organic light-emitting diode (AMOLED) panel according to an exemplary embodiment;

FIG. 4 is a plan view of an example of a pixel arrangement of a display panel;

FIG. 5 is a schematic cross-sectional view of a touch sensor according to an exemplary embodiment;

FIG. 6 is a plan view of a first electrode layer and a second electrode layer according to an exemplary embodiment;

FIG. 7 is a plan view of a first electrode layer and a second electrode layer according to an exemplary embodiment;

FIG. 8 is a plan view of a first electrode layer and a second electrode layer according to an exemplary embodiment;

FIGS. 9 and 10 show examples of a random pattern layer;

FIG. 11 is a schematic cross-sectional view of a touch sensor according to an exemplary embodiment;

FIG. 12 is a schematic cross-sectional view of a touch sensor according to an exemplary embodiment;

FIG. 13 is a schematic cross-sectional view of a touch sensor according to an exemplary embodiment;

FIG. 14 is a schematic cross-sectional view of a display device according to an exemplary embodiment;

FIG. 15 is a schematic cross-sectional view of a display device according to an exemplary embodiment;

FIG. 16 is a schematic cross-sectional view of a display device according to an exemplary embodiment; and

FIG. 17 is a schematic cross-sectional view of a display device according to an exemplary embodiment.

### DETAILED DESCRIPTION

Reference will now be made in detail to various exemplary embodiments, which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects. Expressions such as “at least one of,” when preceding a list of elements, modify the entire list of elements and do not modify the individual elements of the list.

Although terms used in the present disclosure are selected with general terms popularly used at present under the consideration of functions in the present disclosure, the terms may vary according to the intention of those of ordinary skill in the art, judicial precedents, or introduction of new technology. In addition, in some cases, specific terms may be selected, and the meaning of the terms may be disclosed in the corresponding description of the disclosure. Thus, the terms used in the present disclosure may be defined not only by the descriptive names of the terms but also by the meaning of the terms and the contents provided by the present disclosure.

In a description of the exemplary embodiments, when a part is connected to another part, the part may not only be directly connected to another part but may also be electrically connected to another part with yet another device intervening between them. If it is assumed that a certain part includes a certain component, the term “including” means that a corresponding component may further include other components unless noted otherwise. The term used in the embodiments such as “unit” or “module” indicates a unit for processing at least one function or operation, and may be implemented with hardware, software, or a combination of hardware and software.

The term such as “comprise” or “include” used in the embodiments should not be interpreted as including all of elements or operations described herein, and may be interpreted as excluding some of the elements or operations or as further including additional elements or operations.

Although the terms such as “first” and “second” used in the exemplary embodiments of the present disclosure may modify various elements of the various exemplary embodiments, these terms do not limit the corresponding elements. These terms may be used for the purpose of distinguishing one element from another element.

The following description of the exemplary embodiments should not be construed as limiting the scope of the present disclosure, and what may be easily deduced by those of ordinary skill in the art should be construed as falling within the scope of the present disclosure. Hereinafter, exemplary embodiments for illustration will be described in detail with reference to the accompanying drawings.

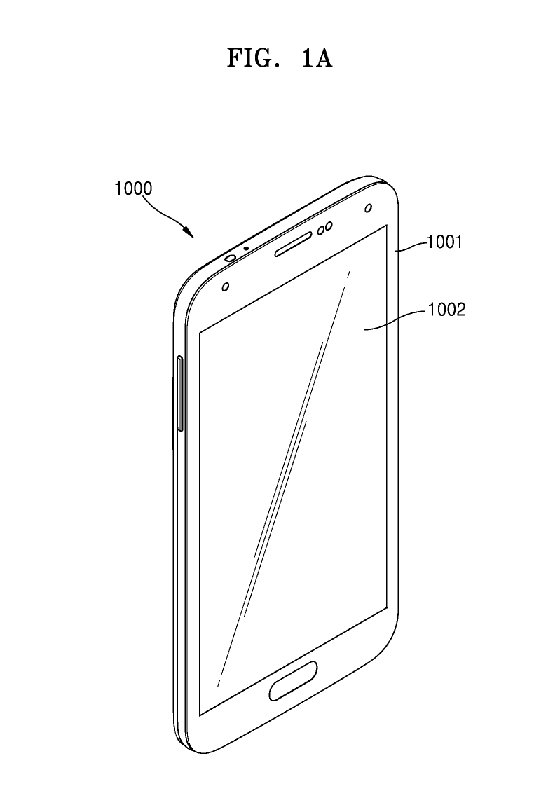

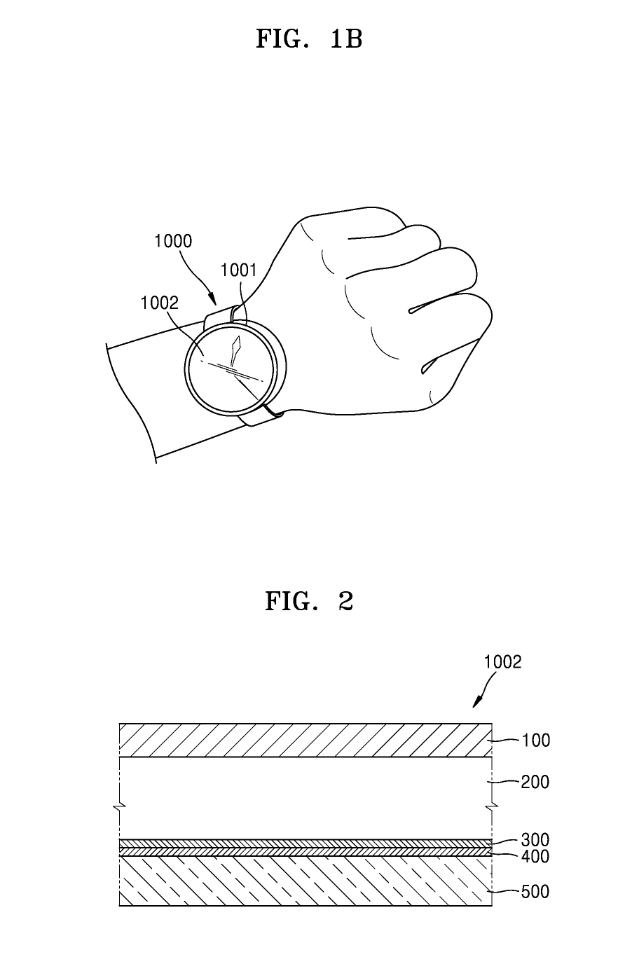

FIGS. 1A and 1B are perspective views of an electronic device 1000 according to an exemplary embodiment. Referring to FIGS. 1A and 1B, the electronic device 1000 may include a body 1001 and a display device 1002 housed in the body 1001.

In the body 1001, a processing unit for performing functions corresponding to the use of the electronic device 1000 and input/output (I/O) interface may be provided. If the electronic device 1000 is a multimedia terminal through which a user may watch videos or listen to music, the processing unit may include a video/audio information processing unit. If the electronic device 1000 is a communication terminal, the processing unit may include a communication module. The I/O interface may include a video/audio I/O unit and an input unit for receiving user inputs.

The electronic device 1000 may be a portable mobile device, for example, a communication terminal such as a smartphone illustrated in FIG. 1A, a smart watch illustrated in FIG. 1B, etc., or a multimedia terminal, a portable computer, a wearable device, etc. In addition to the above examples, the electronic device 1000 may be any device including a display device 1002.

FIG. 2 is a schematic cross-sectional view of the display device 1002 according to an exemplary embodiment. Referring to FIG. 2, the display device 1002 may include a display panel 500 that displays an image and also include a plurality of panels that are stacked one on top of another. The plurality of panels may include a protection panel 200 and a touch sensor 100.

The protection panel 200 is located outside the display panel 500 to protect the display panel 500 against an external shock, a scratch, and so forth. The protection panel 200 is formed of a transparent material to allow an image displayed on the display panel 500 to be seen from the outside.

The touch sensor 100 is a sensor capable of recognizing a fingerprint. The touch sensor 100 is located outside the protection panel 200 to improve the sensitivity of sensing. The touch sensor 100 may be located outermost in the display device 1002. The touch sensor 100 may partially or totally cover the protection panel 200. As will be described later, if the touch sensor 100 functions also as a touch panel 300, the touch sensor 100 may totally cover the protection panel 200. A detailed structure of the touch sensor 100 will be described later.

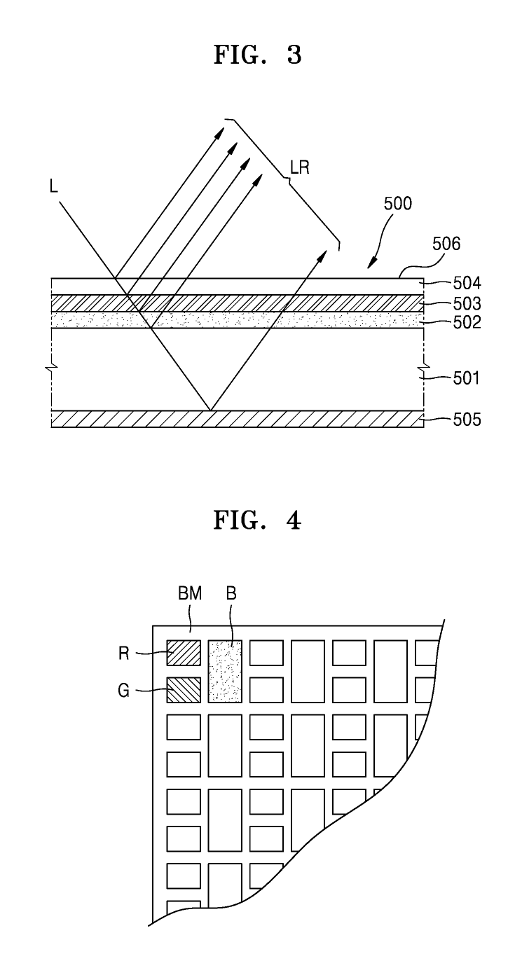

The display panel 500 may be an active matrix organic light-emitting diode (AMOLED) panel. FIG. 3 is a schematic cross-sectional view of an AMOLED panel according to an exemplary embodiment.

Referring to FIG. 3, the display panel 500 may include a driving board 501 where a driving device array (e.g., a thin film transistor (TFT) array) is arranged, an organic electroluminescence layer 502, a cathode electrode layer 503, and an encapsulation layer 504. A color filter layer may be further interposed between the organic electroluminescence layer 502 and the encapsulation layer 504. Under the driving board 501, a reflection layer 505 for emitting light toward the encapsulation layer 504 (i.e., toward a light-emission surface 506) may be provided. The organic electroluminescence layer 502 or the color filter layer may, as an example, have a structure in which red (R), green (G), and blue (B) pixels are periodically arranged (e.g., at regular intervals) on a block matrix (BM) as shown in FIG. 4. If a liquid crystal display (LCD) panel is adopted as the display panel 500, pixels of the color filter may also be arranged to have the example structure illustrated in FIG. 4.

A structure of the AMOLED panel is well known in the art, and thus will not be described in detail. The AMOLED panel is a self-emitting type display panel, in which light is generated from the organic electroluminescence layer 502 by a driving signal, and thus does not need a separate light source (e.g., a backlight) unlike an LCD panel. Thus, the AMOLED panel may be manufactured to be much thinner than the LCD panel.

The plurality of panels may further include the touch panel 300. The touch panel 300 may be, for example, interposed between the protection panel 200 and the display panel 500. The touch panel 300 is an example of the input unit for receiving a user input. The touch panel 300 may be, for example, a capacitive touch panel. The touch panel 300 may include a light-transmissive base substrate and a light-transmissive touch electrode layer. The touch electrode layer may include a plurality of horizontal electrodes, a plurality of vertical electrodes, and a dielectric layer interposed between the plurality of horizontal electrodes and the plurality of vertical electrodes. A structure of the touch panel 300 is similar to a structure of the touch sensor 100 described later, and thus a repeated description thereof will be avoided. The touch panel 300 may be substantially identical to the touch sensor 100 except for a pitch between the plurality of horizontal electrodes and a pitch between the plurality of vertical electrodes, such that the touch panel 300 may be omitted and the touch sensor 100 may function also as a touch panel.

As shown in FIG. 2, the plurality of panels may further include a polarization panel 400. The polarization panel 400 functions to solve problems such as glare, contrast ratio degradation, and so forth, caused by reflection of external light incident to the display panel 100. Although the polarization panel 400 is positioned between the touch panel 300 and the protection panel 200 in FIG. 2, a position of the polarization panel 400 is not particularly limited as long as the polarization panel 400 is located outside the display panel 500. If there is no polarization panel 200, external light L incident from the outside to the display panel 500 is reflected by a surface layer of the display panel 500, i.e., the light-emitting surface 506, each layer forming the display panel 500, and the reflection layer 505 that is the bottom layer of the display panel 500, and is then emitted to the outside, as shown in FIG. 3. Reflected light LR degrades a contrast ratio of an image and causes glare. The polarization panel 400 is an anti-reflection panel that reduces or prevents the reflected light LR of the external light L.

The polarization panel 400 may include a linear polarizer and an λ/4 phase plate. The linear polarizer linearly polarizes incident light. The λ/4 phase plate circularly polarizes linearly polarized light, and in turn, linearly polarizes circularly polarized light. Once the external light L, which is unpolarized light, passes through the linear polarizer, it may be converted into, for example, horizontal linearly polarized light. Once the horizontal linearly polarized light passes through the λ/4 phase plate, it may be converted into, for example, left circular polarized light. Once the left circular polarized light is incident to the display panel 500 and is reflected from the surface layer of the display panel 500, each layer of the display panel 500, and the bottom layer of the display panel 500 (i.e., the reflection layer 505), the left circular polarized light is converted into right circular polarized light. If the right circular polarized light passes through the λ/4 phase plate, it is converted back into linearly polarized light, and in this case, the polarization direction of the linearly polarized light may be, for example, a vertical direction. The vertical linearly polarized light is reflected back inside, failing to pass through the linear polarizer, and is not emitted from the polarization panel 400. In this way, the polarization panel 400 reduces or removes the reflected light LR, thereby reducing glare and preventing contrast ratio degradation. A structure of the polarization panel 400 is well known in the art, and thus will not be described in detail. The polarization panel 400 may further include various optical layers for improving the performance of the display panel 500 (e.g., a phase difference correction layer, a viewing angle correction layer, and so forth).

The display panel 500, the polarization panel 400, the touch panel 300, the protection panel 200, and the touch sensor 100 are adhered to one another by, for example, an optically clear adhesive (OCA) or an optically clear resin (OCR).

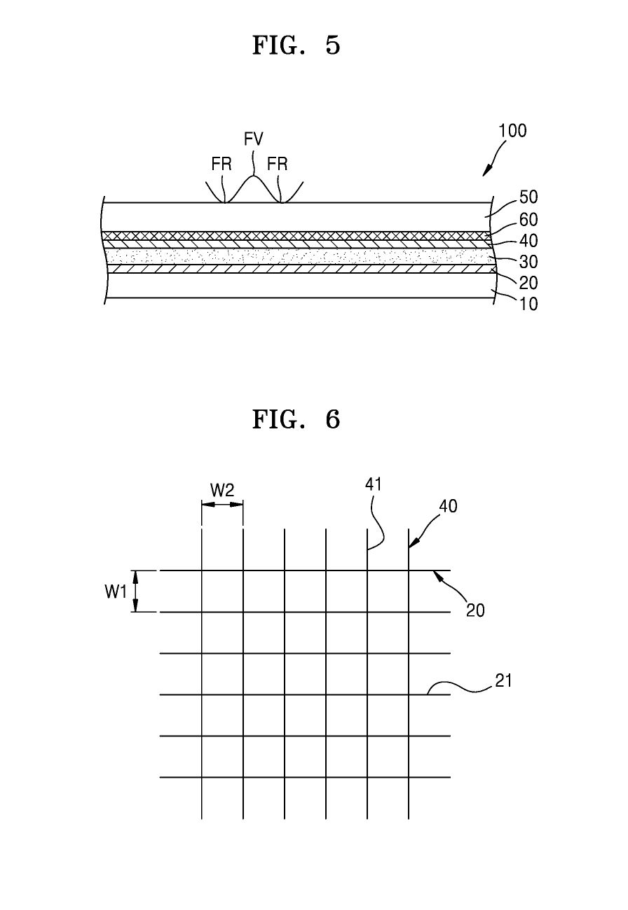

FIG. 5 is a schematic cross-sectional view of the touch sensor 100 according to an exemplary embodiment. Referring to FIG. 5, the touch sensor 100 may include a substrate 10, an electrode layer, and a transparent cover 50. The electrode layer may include a first electrode layer 20 and a second electrode layer 40 that intersect each other, and a dielectric layer 30 interposed between the first electrode layer 20 and the second electrode layer 40.

If the touch sensor 100 is applied to the display device 1002, the substrate 10 may be a transparent substrate. The substrate 10 may be, for example, a glass substrate, a polymer substrate, or the like.

By forming a patterned thin film on the substrate 10 with a conductive material such as indium tin oxide (ITO), a copper metal mesh, a silver nanowire, etc., using vacuum deposition, sputtering, plating, etc., the first electrode layer 20 may be formed. The dielectric layer 30 is formed on the first electrode layer 20, and the second electrode layer 40 may be formed by forming a patterned thin film on the dielectric layer 30 with a conductive material by vacuum deposition, sputtering, plating, etc.

FIG. 6 is a plan view of the first electrode layer 20 and the second electrode layer 40 according to an exemplary embodiment. Referring to FIG. 6, the first electrode layer 20 may include a plurality of horizontal electrodes 21, and the second electrode layer 40 may include a plurality of vertical electrodes 41. The plurality of horizontal electrodes 21 and the plurality of vertical electrodes 41 may be linear electrodes. A region of intersection between the horizontal electrode 21 and the vertical electrode 41 is a sensing cell. If a linear electrode is formed of a metal material having low resistivity, such as aluminum (Al), copper (Cu), molybdenum (Mo), chromium (Cr), an Ag—Pd—Cu (APC) alloy, silver (Ag), etc., a width of the linear electrode may be less than, for example, about 3 μm.

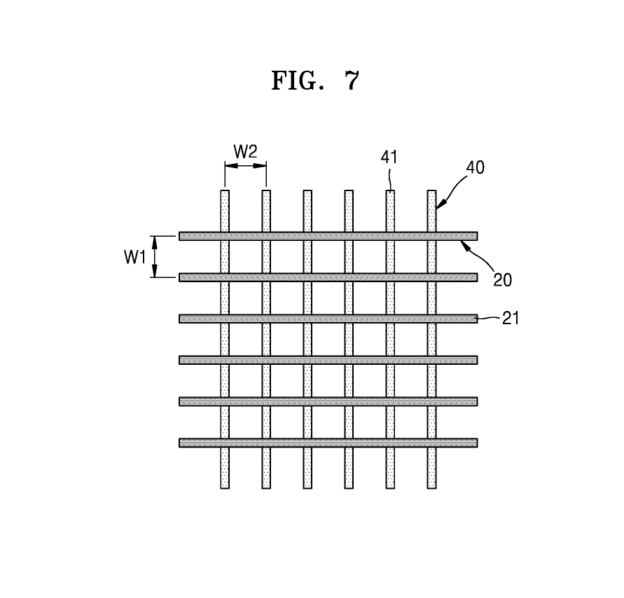

FIG. 7 is a plan view of the first electrode layer 20 and the second electrode layer 40 according to an exemplary embodiment. Referring to FIG. 7, the first electrode layer 20 may include the plurality of horizontal electrodes 21, and the second electrode layer 40 may include the plurality of vertical electrodes 41. The plurality of horizontal electrodes 21 and the plurality of vertical electrodes 41 may be bar-type electrodes. A region of intersection between the horizontal electrode 21 and the vertical electrode 41 is a sensing cell.

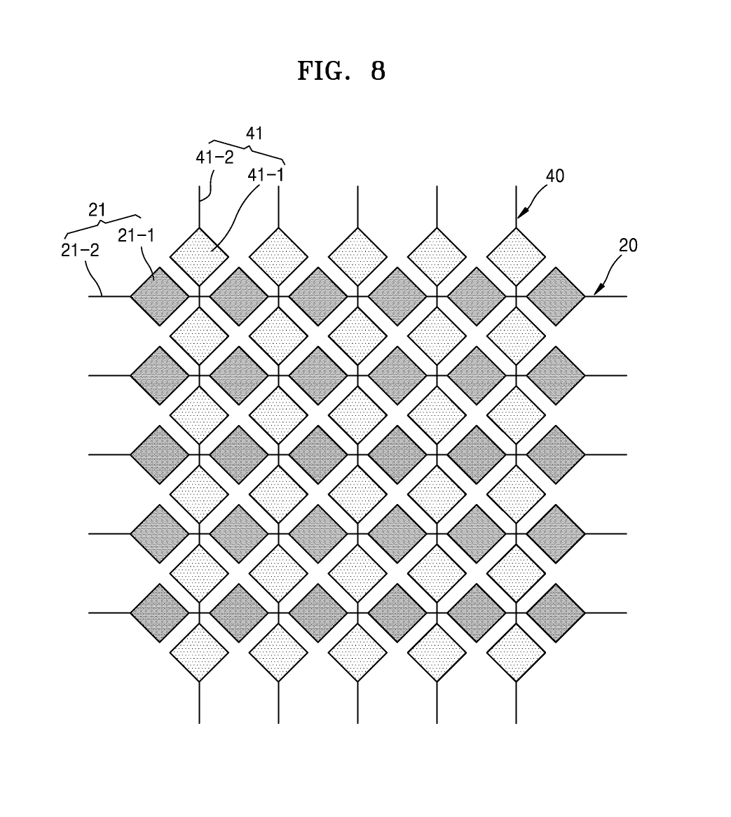

FIG. 8 is a plan view of the first electrode layer 20 and the second electrode layer 40 according to an exemplary embodiment. Referring to FIG. 8, the first electrode layer 20 may include the plurality of horizontal electrodes 21, and the second electrode layer 40 may include the plurality of vertical electrodes 41. Each horizontal electrode 21 may include a plurality of diamond patterns 21-1 and a linear pattern 21-2 connecting the plurality of diamond patterns 21-1. Likewise, each vertical electrode 41 may include a plurality of diamond patterns 41-1 and a linear pattern 41-2 connecting the plurality of diamond patterns 41-1. A region of intersection between the linear pattern 21-2 and the linear pattern 41-2 is a sensing cell. Although the diamond patterns 21-1 and 41-1 are shown in FIG. 8, patterns of various shapes such as a hexagonal pattern, etc., may be used in place of the diamond patterns 21-1 and 41-1.

Each of the bar-type electrodes and the diamond patterns 21-1 and 41-1 illustrated in FIGS. 7 and 8 is a solid pattern in which the inside of the pattern is filled with a conductive material. If the touch sensor 100 is installed on a display surface of a display panel, the solid pattern may affect a screen of the display panel. Thus, in this case, the first electrode layer 20 and the second electrode layer 40 may be formed of a transparent electrode material such as ITO, etc.

The diamond patterns 21-1 and 41-1 illustrated in FIG. 8 may be linear patterns having an empty space inside. In this case, a linear pattern may be formed of a metal material having low resistivity, such as aluminum (Al), copper (Cu), molybdenum (Mo), chromium (Cr), an Ag—Pd—Cu (APC) alloy, silver (Ag), etc. The line width of the linear pattern may be less than, for example, 3 μm.

The first electrode layer 20 and the second electrode layer 40 may have various forms without being limited to the examples shown in FIGS. 6 through 8.

The touch sensor 100 according to the current embodiment is a capacitive touch sensor. Electrodes of the first electrode layer 20 (i.e., the plurality of horizontal electrodes 21) may be driving electrodes, and electrodes of the second electrode layer 40 (i.e., the plurality of vertical electrodes 41) may be receiving electrodes. A driving circuit for applying a driving voltage to a driving electrode and a detecting circuit for detecting capacitive information from the receiving electrode may be further provided on the substrate 10. Each of the driving circuit and the detecting circuit may be, for example, a complementary metal oxide semiconductor (CMOS) circuit structure. In another example, when the touch sensor 100 is applied to another electronic device, the driving circuit and the detecting circuit may be provided on a control circuit of the electronic device, and the driving electrode and the receiving electrode may be electrically connected to the control circuit of the electronic device.

Once a finger contacts the transparent cover 50, a mutual capacitance between the horizontal electrodes 21 and the vertical electrodes 41 which are adjacent to the region of finger contact may change. The change in the mutual capacitance may differ from electrodes 21 and 41 adjacent to a ridge FR of a fingerprint to electrodes 21 and 41 adjacent to a valley FV of the fingerprint. When an interval W1 between horizontal electrodes 21 and an interval W2 between vertical electrodes 41 are each smaller than an interval between the ridge FR and the valley FV, a user's fingerprint pattern information may be obtained by obtaining a mutual capacitance difference between each horizontal electrode 21 and each vertical electrode 41. A pitch between a ridge and a valley of a fingerprint is about 600 μm to about 700 μm, such that W1 and W2 are less than the pitch.

The display device 1002 has a form in which the display panel 500 and the touch sensor 100 overlap each other as shown in FIG. 2. The pixel pattern of the display panel 500 and the electrode pattern of the touch sensor 100 are periodically repeated, and thus if the pixel pattern and the electrode pattern overlap each other, the Moire phenomenon may occur. The Moire phenomenon may distort an image displayed by the display panel 500 or induce a dizzying sensation in a user observing the image, thereby degrading the image quality of the display device 1002. The Moire phenomenon may worsen if the pixel pattern of the display panel 500 becomes finer in order to implement a higher resolution, or when a low-resistance metal electrode is used as an electrode of the touch sensor 100 to improve sensing sensitivity.

To reduce the Moire phenomenon, overlapping patterns must not be periodic (e.g., regular), and a boundary form and a period (e.g., interval) of the overlapping patterns need to be random. However, a pixel pattern of the display panel 500 has to be periodic and repetitive, and in order for the entire area of the touch sensor to accurately sense a fingerprint with identical sensitivity, an area, a pitch, a form, and so forth of electrodes have to be periodic and repetitive. Thus, to reduce or prevent the Moire phenomenon, a scheme for changing an electrode pattern, for example, by adjusting a line width, a pitch, an angle, and so forth of the electrodes, may be difficult to apply.

The Moire phenomenon may be reduced by introducing a random. Thus, the touch sensor 100 according to an exemplary embodiment further includes a random pattern layer 60 in which an aperiodic pattern is formed as shown in FIG. 5.

In FIG. 5, the random pattern layer 60 is formed on a bottom surface (inner surface) of the transparent cover 50. Herein, the bottom surface (inner surface) refers to a surface opposing a top surface (outer surface) that a finger makes contact. The random pattern layer 60 may be implemented by applying, for example, ITO, SiO₂, a light-transmissive polymer, metal, etc., onto the bottom surface of the transparent cover 50 using a method such as deposition, sputtering, plating, nano printing, or the like, to form an aperiodic pattern. The random pattern layer 60 may also be implemented by etching the bottom surface of the transparent cover 50 to form an aperiodic pattern. When the random pattern layer 60 is formed of metal, a pattern density may be appropriately adjusted to minimize influence upon light transmittance.

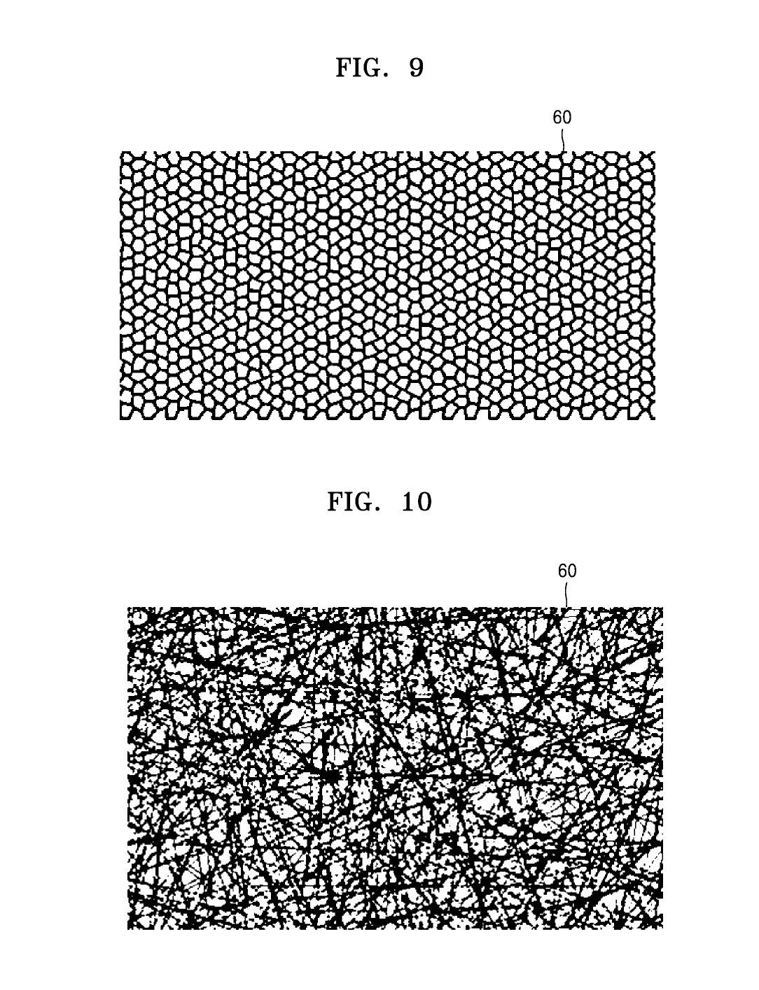

As such, once the random pattern layer 60 further overlaps two periodic patterns (i.e., the pixel pattern of the display panel 500 and the electrode pattern of the touch sensor 100), an interference pattern is reduced, thus reducing the Moire phenomenon. This effect may be seen through optical simulation using light ray tracing. FIGS. 9 and 10 show examples of the random pattern layer 60. There may be various aperiodic patterns, for example, a Voronoi diagram, a Delaunay triangle, and so forth, and an aperiodic pattern capable of minimizing the Moire phenomenon may be determined while changing a parameter of the aperiodic pattern using optical simulation.

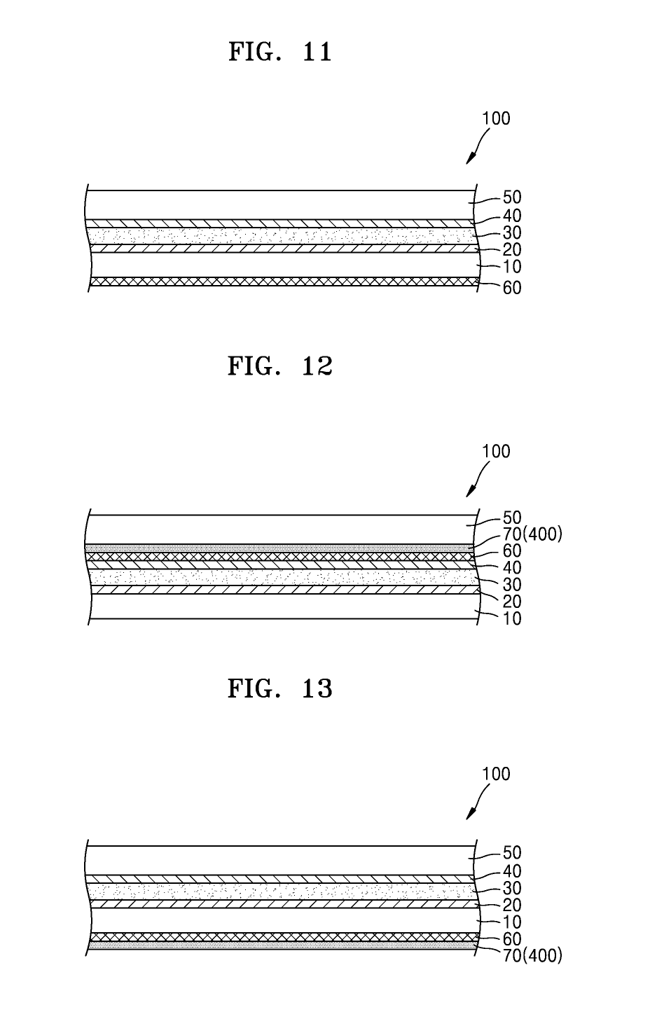

FIG. 11 is a schematic cross-sectional view of the touch sensor 100 according to an exemplary embodiment. Referring to FIG. 11, the touch sensor 100 may include the substrate 10, the first electrode layer 20 and the second electrode layer 40 facing each other and having the dielectric layer 30 therebetween, and the transparent cover 50. The first electrode layer 20 and the second electrode layer 40 may have various forms, for example, forms shown in FIGS. 6 through 8. The random pattern layer 60 is formed on a bottom surface of the substrate 10. The random pattern layer 60 may be implemented by applying, for example, ITO, SiO₂, a light-transmissive polymer, metal, etc., onto the bottom surface of the substrate 10 using a method such as deposition, sputtering, plating, nano printing, or the like, to form an aperiodic pattern, as described above. The random pattern layer 60 may also be implemented by etching the bottom surface of the substrate 10 to form an aperiodic pattern.

FIGS. 12 and 13 are schematic cross-sectional views of the touch sensor 100 according to exemplary embodiments. Referring to FIG. 12, the touch sensor 100 may include the substrate 10, the first electrode layer 20 and the second electrode layer 40 facing each other and having the dielectric layer 30 therebetween, and the transparent cover 50. The first electrode layer 20 and the second electrode layer 40 may have various forms, for example, forms shown in FIGS. 6 through 8. The random pattern layer 60 is formed on a support plate 70. The random pattern layer 60 may be formed on a bottom surface of the support plate 70. The random pattern layer 60 may be implemented by applying, for example, ITO, SiO₂, a light-transmissive polymer, metal, etc., onto the bottom surface of the support plate 70 using a method such as deposition, sputtering, plating, nano printing, or the like, to form an aperiodic pattern, as described above. The random pattern layer 60 may also be implemented by etching the bottom surface of the support plate 70 to form an aperiodic pattern. The random pattern layer 60 may be formed on a top surface of the support plate 70.

As shown in FIG. 12, the support plate 70 on which the random pattern layer 60 is formed may be adhered to the transparent cover 50 and the second electrode layer 40 using an OCA or an OCR.

As shown in FIG. 13, the support plate 70 on which the random pattern layer 60 is formed may be adhered to the bottom surface of the substrate 10.

The support plate 70 may be the polarization panel 400 described with reference to FIG. 2. That is, the polarization panel 400 may function as the support plate 70 of the random pattern layer 60. In this case, the random pattern layer 60 may be formed on a bottom surface or a top surface of the polarization panel 400. If the polarization panel 400 on which the random pattern layer 60 is formed is included in the touch sensor 100, the polarization panel 400 may be omitted from the display device shown in FIG. 2.

Although the random pattern layer 60 is described as being formed in the touch sensor 100 in the foregoing embodiments, the random pattern layer 60 may be formed in various panels of the display device 1002.

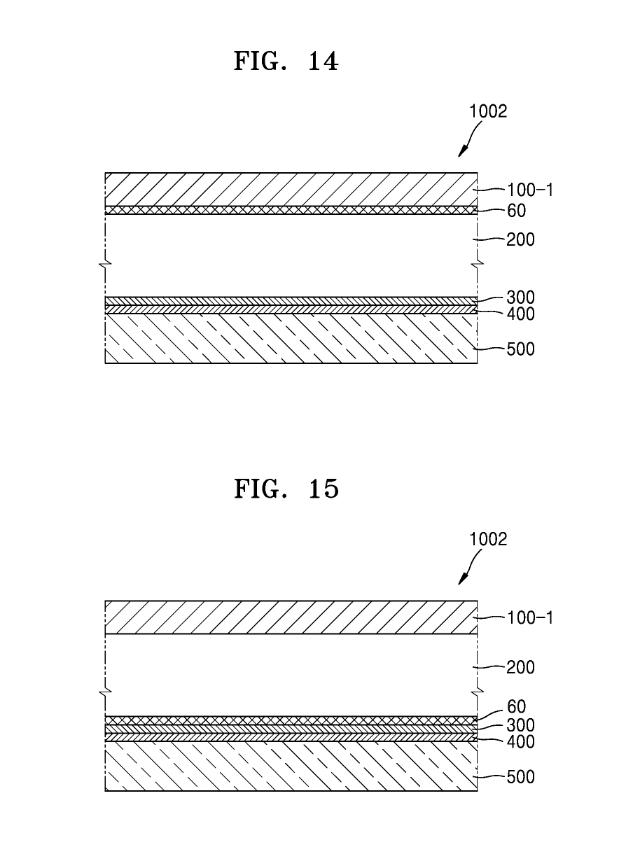

FIGS. 14 through 16 are cross-sectional views of the display device 1002 according to exemplary embodiments. In exemplary embodiments illustrated in FIGS. 14 through 17, a touch sensor 100-1 is a form in which the random pattern layer 60 is omitted from the touch sensor 100 shown in FIGS. 5 through 13.

Referring to FIGS. 14 and 15, the random pattern layer 60 may be formed on a bottom surface or a top surface of the protection panel 200. The random pattern layer 60 may be implemented by applying, for example, ITO, SiO₂, a light-transmissive polymer, metal, etc., onto the bottom surface or the top surface of the protection panel 200 using a method such as deposition, sputtering, plating, nano printing, or the like, to form an aperiodic pattern, as described above. The random pattern layer 60 may also be implemented by etching the bottom surface or the top surface of the protection panel 200 to form an aperiodic pattern.

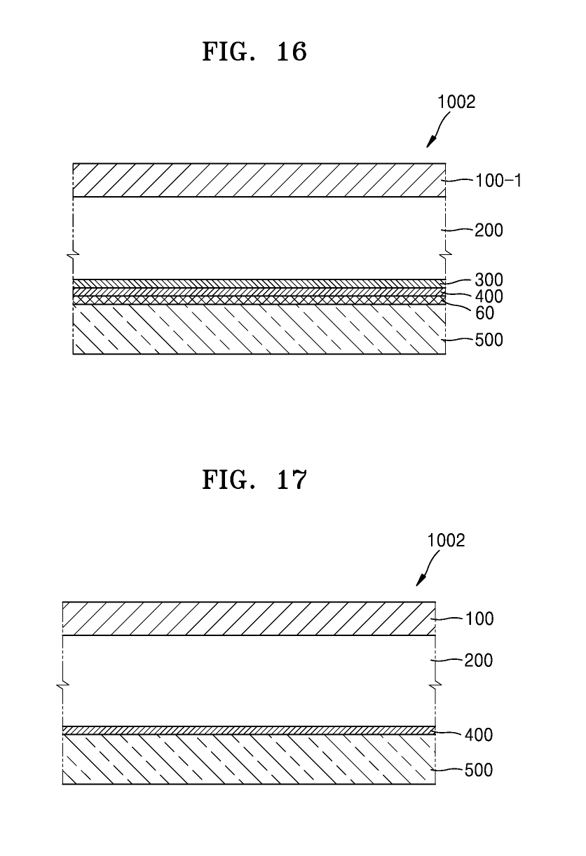

Referring to FIG. 16, the random pattern layer 60 is formed on the polarization panel 400. The random pattern layer 60 may be formed on a bottom surface of the polarization panel 400. The random pattern layer 60 may be implemented by applying, for example, ITO, SiO₂, a light-transmissive polymer, metal, etc., onto the bottom surface of the polarization panel 400 using a method such as deposition, sputtering, plating, nano printing, or the like, to form an aperiodic pattern, as described above. Alternatively, the random pattern layer 60 may be formed on a top surface of the polarization panel 400.

The display device 1002 shown in FIGS. 2 and 14 through 16 further includes the touch panel 300 separate from the touch sensor 100, but the touch sensor 100 may also function as the touch panel 300 as described above. In this case, the display device 1002 may not include the touch panel 300, as shown in FIG. 17. The touch sensor 100 may have a form as shown in FIGS. 5 through 13.

While the touch sensor, the display device including the touch sensor, and the electronic device including the touch sensor have been shown and described in connection with the exemplary embodiments, it will be apparent to those of ordinary skill in the art that modifications and variations may be made without departing from the spirit and scope of the exemplary embodiments as defined by the appended claims. Therefore, exemplary embodiments should be considered in an illustrative sense rather than a restrictive sense. All of the differences in the equivalent range thereof should be understood to be included in the exemplary embodiments.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A touch sensor comprising:
a substrate;
an electrode layer disposed on a top surface of the substrate, the electrode layer comprising a first electrode layer and a second electrode layer that intersect each other, and a dielectric layer disposed between the first electrode layer and the second electrode layer;
a transparent cover disposed on the electrode layer; and
a random pattern layer comprising an aperiodic pattern.

2. The touch sensor of claim 1, wherein the random pattern layer is disposed on a bottom surface of the transparent cover.

3. The touch sensor of claim 1, wherein the random pattern layer is disposed on a bottom surface of the substrate.

4. The touch sensor of claim 1, further comprising a support plate including the random pattern layer.

5. The touch sensor of claim 1, further comprising a polarization panel configured to reduce reflected light of external light,
wherein the random pattern layer is disposed on the polarization panel.

6. A display device comprising:
a display panel configured to display an image;
a protection panel disposed outside the display panel;
a touch sensor disposed outside the protection panel and comprising a substrate, an electrode layer disposed on a top surface of the substrate, and a transparent cover disposed on the electrode layer, wherein the electrode layer comprises:
a first electrode layer and a second electrode layer that intersect each other, and
a dielectric layer disposed between the first electrode layer and the second electrode layer; and
a random pattern layer comprising an aperiodic pattern.

7. The display device of claim 6, wherein the random pattern layer is disposed on a bottom surface of the transparent cover.

8. The display device of claim 6, wherein the random pattern layer is disposed on a bottom surface of the substrate.

9. The display device of claim 6, wherein the touch sensor further comprises a support plate, and
wherein the random pattern layer is disposed on the support plate.

10. The display device of claim 6, wherein the touch sensor further comprises a polarization panel configured to reduce reflected light of external light, and
wherein the random pattern layer is disposed on the polarization plate.

11. The display device of claim 6, wherein the random pattern layer is disposed on one of a top surface and a bottom surface of the protection panel.

12. The display device of claim 6, wherein the random pattern layer is disposed on a bottom surface of the display panel.

13. The display device of claim 6, further comprising a polarization panel configured to reduce reflected light of external light,
wherein the random pattern layer is disposed on the polarization plate.

14. The display device of claim 6, further comprising a touch panel for receiving a user input, the touch panel disposed between the protection panel and the display panel.

15. The display device of claim 6, wherein the touch sensor functions as a touch panel for receiving a user input.

16. An electronic device comprising:
a body; and
a display device supported in the body, the display device comprising:
a display panel configured to display an image,
a protection panel disposed outside the display panel,
a touch sensor disposed outside the protection panel and comprising:
a substrate,
an electrode layer disposed on a top surface of the substrate and comprising a first electrode layer and a second electrode layer that intersect each other, and a dielectric layer disposed between the first electrode layer and the second electrode layer, and
a transparent cover disposed on the electrode layer, and
a random pattern layer comprising an aperiodic pattern.

17. The electronic device of claim 16, wherein the random pattern layer is disposed on one of a bottom surface of the transparent cover, a bottom surface of the substrate, a top surface of the protection panel, a bottom surface of the protection panel, and a bottom surface of the display panel.

18. The electronic device of claim 16, wherein the touch sensor further comprises a support plate, and
wherein the random pattern layer is disposed on the support plate.

19. The electronic device of claim 16, further comprising a polarization panel configured to reduce reflected light of external light,
wherein the random pattern layer is disposed on the polarization panel.

20. The electronic device of claim 16, further comprising a touch panel for user input, the touch panel disposed between the protection panel and the display panel.
